(19) United States
(12) Patent Application Publication
(10) Pub. No.: US 2008/0084502 A1
(43) Pub. Date: Apr. 10, 2008

(54) METHOD AND APPARATUS FOR TRANSMITTING/RECEIVING DATA

(75) Inventors: Chang-woo LEE, Suwon-si (KR); Sang-jin LEE, Seoul (KR); Jin-sub UM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/851,454

(22) Filed: Sep. 7, 2007

(30) Foreign Application Priority Data
Oct. 4, 2006 (KR) 10-2006-0097552

(51) Int. Cl. H04N 7/088; H04N 7/087

(52) U.S. Cl. 348/465; 348/468; 348/E07.033; 348/E07.034

(57) ABSTRACT

A data transmitting/receiving apparatus and method in which color gamut information is added to a teletext signal in a blanking interval so that a display device can recognize whether a color gamut has been extended, are provided. The apparatus includes a control unit which determines whether an image signal is a wide color gamut signal. A signal processing unit encodes color gamut information of the wide color gamut signal and allocates the color gamut information to a data region of a teletext interval if it is determined that the image signal is the wide color gamut signal. The signal processing unit transmits an image signal including a teletext packet in which the color gamut information is recorded.

### CROSS-REFERENCE TO RELATED PATENT APPLICATION

This application claims priority from Korean Patent Application No. 10-2006-0097552, filed on Oct. 4, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to a teletext transmitting/receiving system, and more particularly, a method and apparatus for transmitting/receiving data, in which color gamut information is added to a teletext signal in a blanking interval so that a display device can recognize whether a color gamut has been extended.

2. Description of the Related Art

Typical multimedia systems include a multimedia source (such as, a DVD player or a set top box) for providing a multimedia signal, and a multimedia output device (such as, a TV) for outputting the multimedia signal received from the multimedia source.

The color gamut represented by either a BT.601 color signal or a YCbCr color signal corresponds to about ⅓ of the color gamut that a human can perceive. With advances in image encoding apparatuses, a multimedia output device is capable of capturing a color signal having a wider gamut than the existing YCbCr gamut.

A related art multimedia source transmits signals that conform to the types of interface or the types of signal. Multimedia interfaces, such as a digital visual interface (DVI), or an analog transmission standard, provide no structure for transmitting color gamut information such as an extended video YCbCr (xvYCC) color signal. Therefore, the existing multimedia output devices have difficulty in reproducing an extended color gamut because it is difficult to check whether a color gamut has been extended.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. The present invention provides a data transmitting/receiving method in which color gamut information is added to a teletext signal in a blanking interval so that a display device can recognize whether a color gamut has been extended.

The present invention also provides a data transmitting/receiving apparatus which adds wide color gamut information to a teletext signal and recognizes extension or non-extension of a wide color gamut from the teletext signal.

According to an aspect of the present invention, there is provided a data transmitting method, in which it is determined whether an image signal is a wide color gamut signal. Then, if it is determined that the image signal is the wide color gamut signal, a teletext interval is detected from lines of the image signal. Next, color gamut information that indicates that the image signal relates to a color gamut is encoded, and the encoded color gamut information is allocated to a data region of the teletext interval. Thereafter, an image signal including a teletext packet in which the encoded color gamut information is recorded is transmitted.

According to another aspect of the present invention, there is provided a data receiving method including the operations of receiving an image signal including a teletext signal in a blanking interval to which coded color gamut information is added, detecting the blanking interval from the received image signal to extract the teletext signal from the image signal, extracting data from the teletext signal, decoding the coded color gamut information from the extracted data, and controlling a color gamut of a display device according to the decoded color gamut information.

According to another aspect of the present invention, there is provided a data receiving device for decoding wide color gamut information from a teletext signal received from a data transmitting device, the teletext signal to which the color gamut information is added, the data receiving device including a decoder unit for detecting a teletext interval included in a received image signal and decoding color gamut information from a data region of the teletext interval, a control unit for detecting color gamut type information from the color gamut information detected from the data region of the teletext interval by the decoder unit, and a signal processing unit for performing wide color gamut mapping using a primary coordinate value of a color channel included in the color gamut information decoded by the decoder unit, according to the color gamut type information detected by the control unit.

### BRIEF DESCRIPTION OF THE DRAWINGS

The above and other features and aspects of the present invention will become more apparent by describing in detail exemplary embodiments thereof with reference to the attached drawings in which:

FIG. 1 illustrates a transmission format of an image signal based on a phase alternation by line (PAL) standard according to an exemplary embodiment of the present invention;

FIG. 2 illustrates a structure of a teletext signal to which color gamut information is to be added, according to an exemplary embodiment of the present invention;

FIG. 3 illustrates a data structure of color gamut information that is encoded in a data region of the teletext signal illustrated in FIG. 2;

FIG. 4 is a detailed diagram of the color gamut information shown in FIG. 3;

FIG. 5 illustrates a method of encoding a color gamut type included in the color gamut information shown in FIG. 4, according to an exemplary embodiment of the present invention;

FIG. 6 illustrates a color gamut of an extended signal compared with a standard YCbCr signal;

FIG. 7 is a block diagram of a data transmitting/receiving apparatus according to an exemplary embodiment of the present invention;

FIG. 8 is a flowcharting illustrating a data transmitting method according to an exemplary embodiment of the present invention; and

FIG. 9 is a flowcharting illustrating a data receiving method according to an exemplary embodiment of the present invention.

### DETAILED DESCRIPTION OF THE EXEMPLARY EMBODIMENTS

The present invention will now be described more fully with reference to the accompanying drawings, in which exemplary embodiments of the invention are shown.

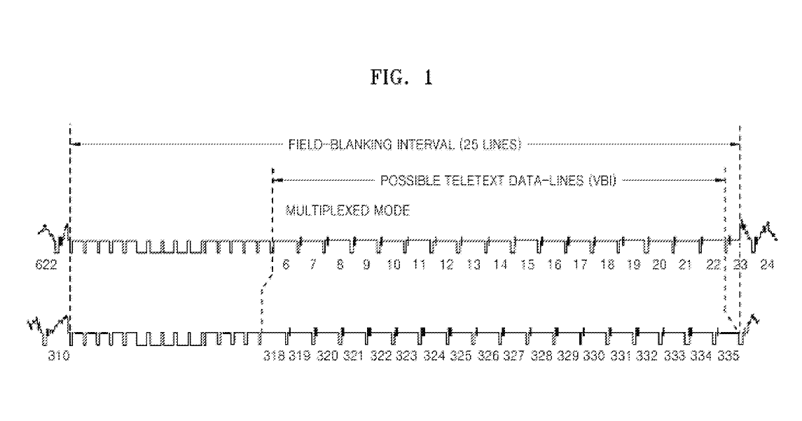

FIG. 1 illustrates a transmission format of an image signal based on a phase alternation by line (PAL) standard according to an exemplary embodiment of the present invention. Referring to FIG. 1, a teletext signal is a packet of image data. The teletext signal is included in lines 6-22 and lines 318-335 of a vertical blanking interval (VBI) of the image signal.

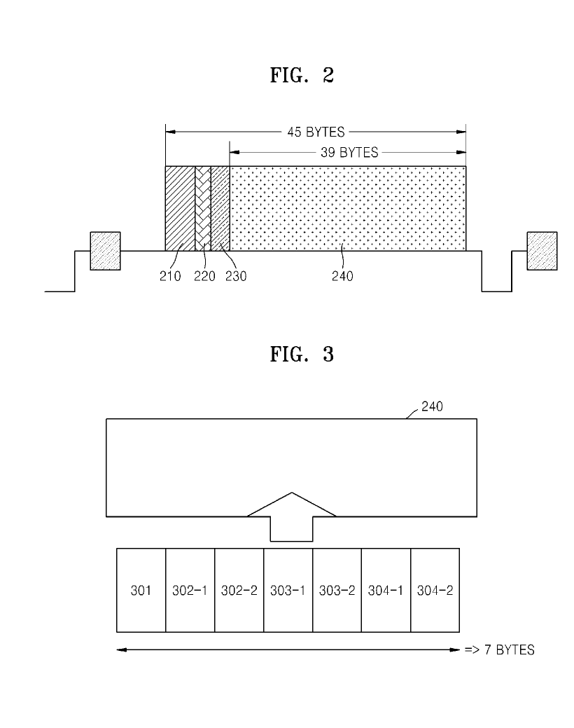

FIG. 2 illustrates a structure of a teletext signal to which color gamut information is to be added, according to an exemplary embodiment of the present invention.

The teletext signal of FIG. 2 is formed of a total of 45 bytes, and includes a clock run in 210, a framing code 220, a magazine number 230, and a data region 240. The data region 240 is made up of a total of 39 bytes and stores image-related information, such as, the name of a broadcasting station and broadcasting programs, which is not displayed on a screen. In this exemplary embodiment, wide color gamut information is encoded in the data region 240 of the teletext signal, and the address of the encoded wide color gamut information is inserted in the header of the teletext signal (i.e., a teletext packet). Here, the color gamut information indicates that the image signal relates to a color gamut.

FIG. 3 illustrates a data structure of the color gamut information that is encoded in the data region 240 illustrated in FIG. 2. Referring to FIG. 3, the color gamut information is allocated to control bits or data bits that are not currently used in the data region 240 of the teletext packet. The area of the color gamut information is divided into a total of 7 bytes, namely, a first byte 301, a second byte 302-1, a third byte 302-2, a fourth byte 303-1, a fifth byte 303-2, a sixth byte 304-1, and a seventh byte 304-2. The color gamut information includes the type of color gamut and the primary coordinate values of the color gamut. The color gamut type is allocated to the first byte 301, and the primary coordinate values are allocated to the second through seventh bytes 302-1 through 304-2.

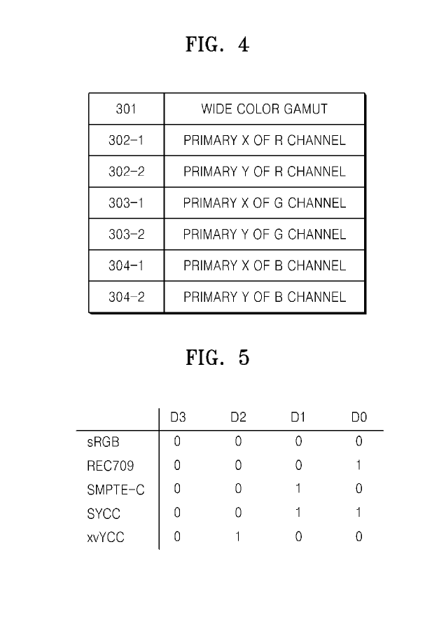

FIG. 4 is a detailed diagram of the color gamut information shown in FIG. 3. The first byte 301 is made up of four bits, and stores the type of the color gamut of an image signal. The color gamut type is important information that indicates the type of color gamut, and thus, it may be error correction coded using, for example, a hamming 8/4 code, in order to achieve error detection and error correction. The color gamut type may include SRGB, SYCC, xvYCC, or the like.

The second through seventh bytes 302-1 through 304-2 store the primary coordinate values of color channels, and each of the second through seventh bytes, 302-1 through 304-2, includes 7 valid data bits and one parity bit.

In other words, the second byte 302-1 stores a primary x-coordinate value of a red (R) channel. The third byte 302-2 stores a primary y-coordinate value of the R channel. The fourth byte 303-1 stores a primary x-coordinate value of a green (G) channel. The fifth byte 303-2 stores a primary y-coordinate value of the G channel. The sixth byte 304-1 stores a primary x-coordinate value of a blue (B) channel. The seventh byte 304-2 stores a primary y-coordinate value of the B channel.

In another exemplary embodiment, when the primary coordinate value of a color channel cannot be expressed in one byte, it may be expressed in two bytes.

FIG. 5 illustrates a method of encoding the color gamut type information illustrated in FIG. 4, according to an exemplary embodiment. Referring to FIG. 5, each color gamut type is represented with D3 through D0. A standard red green blue (SRGB) signal is expressed in the format of “0000”, a BT.1361 (REC 709) signal is expressed in the format of “0001”, an SMPTE-C signal is expressed in the format of “0010”, and a standard YCbCr (SYCC) signal is expressed in the format of “0011”, and an extended video YCbCr (xvYCC) signal is expressed in the format of “0100”.

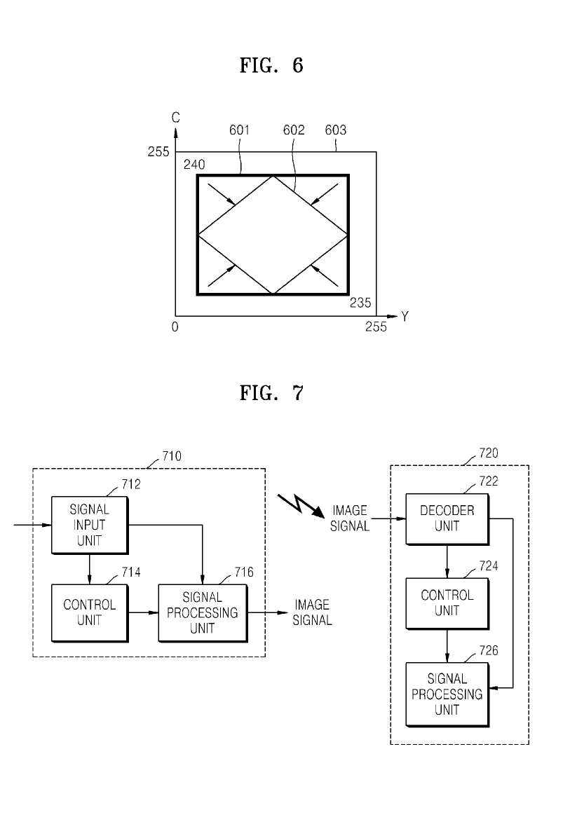

FIG. 6 illustrates a color gamut of an extended signal compared with a standard YCbCr signal. Referring to FIG. 6, the x axis denotes the pixel value of a luminance component of a signal, and the y axis denotes the pixel value of a chrominance component thereof. Reference numeral 601 denotes a color gamut of an SYCC signal, reference numeral 602 denotes a color gamut of an SRGB signal, and reference numeral 603 denotes a color gamut of an xvYCC signal.

FIG. 7 is a block diagram of a data transmitting/receiving apparatus according to an exemplary embodiment of the present invention. The data transmitting/receiving apparatus includes a transmitting device 710 and a receiving device 720 connected to each other by either a wired or wireless connection.

The transmitting device 710 and the receiving device 720 transceive an image signal between each other according to a multimedia transmission standard. For example, like a camcorder or a DVD player, the transmitting device 710 acquires an image signal and generates a teletext signal to which wide color gamut information is added from an image source. The receiving device 720 receives the teletext signal from the transmitting device 710, detects the wide color gamut information from the teletext signal, and displays an image signal suitable for a color gamut indicated by the wide color gamut information.

The transmitting device 710 includes a signal input unit 712, a control unit 714, and a signal processing unit 716.

The signal input unit 712 receives an image signal.

The control unit 714 checks the image signal received by the signal input unit 712 to determine whether the received image signal is a wide color gamut signal. For example, the control unit 714 checks the pixel size of the image signal to determine whether the image signal is a color gamut signal. For example, when the image signal is viewed on a two-dimensional coordinate system, if the pixel size of the image signal is (254, 254), the control unit 714 determines that the image signal is an xvYCC color gamut signal.

If the control unit 714 determines that the image signal is a color gamut signal, the signal processing unit 716 detects a teletext interval from the lines of the image signal, encodes color gamut information, allocates the encoded color gamut information to the data region of the detected teletext interval to obtain a teletext packet, and transmits an image signal including the teletext packet in which the color gamut information is encoded. The color gamut information includes a color gamut type and primary coordinate values of R, G, and B color channels. The signal processing unit 716 also records an address of the teletext interval to the header of the teletext packet.

Referring to FIG. 7, the receiving device 720 includes a decoder unit 722, a control unit 724, and a signal processing unit 726.

The decoder unit 722 detects a teletext interval included in lines 6-22 and lines 318-338 of a received image signal, and decodes color gamut information from a data region of the teletext interval. In other words, the decoder unit 722 decodes a color gamut type and primary xy coordinate values of R, G, and B channels by referring to the address inserted in the header of a teletext packet in which the color gamut information has been encoded. The decoder unit 722 may memorize values of data previous to data from which an error has been detected by the parity bits of the encoded color gamut information, and perform decoding of the previous data instead of decoding the error-detected data.

The control unit 724 detects the color gamut type information from the color gamut information detected from the data region of the teletext interval by the decoder unit 722. For example, with reference to the exemplary embodiment of FIG. 5, when the code value of the color gamut type encoded in the data region is “0000”, the control unit 724 determines that the image signal is an “SRGB” signal. When the code value of the color gamut type encoded in the data region is “0001”, the control unit 724 determines that the image signal is an “REC 709” signal. When the code value of the color gamut type encoded in the data region is “0100”, the control unit 724 determines that the image signal is an “xvYCC” signal.

The signal processing unit 726 performs wide color gamut mapping using the primary x, y coordinate values of the R, G, and B channels decoded by the decoder unit 722, according to the color gamut types determined by the control unit 724. For example, the signal processing unit 726 maps the x and y coordinate values of the R, G, and B channels of the received color gamut signal with the x and y coordinate values of the R, G, and B channels of a display device.

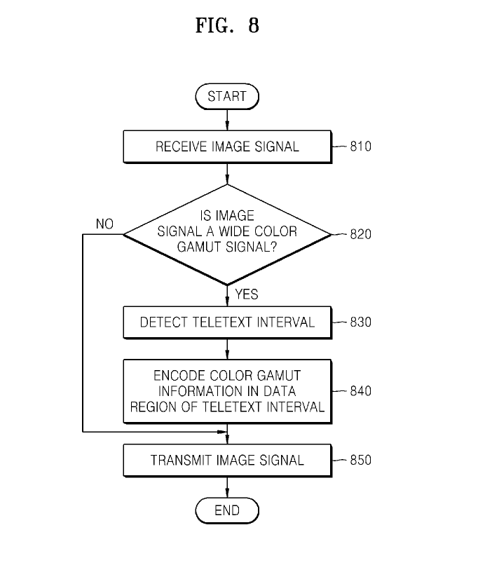

FIG. 8 is a flowchart illustrating a data transmitting method according to an exemplary embodiment of the present invention.

First, in operation 810, an image signal is received.

Then, in operation 820, it is determined whether the image signal is a wide color gamut signal, using the pixel size of the image signal. For example, if the pixel size of the luminance and chrominance components of the image signal is (255, 255), it is determined that the color gamut signal is an xvYCC signal.

Thereafter, in operation 830, when it is determined in operation 820 that the image signal is the wide color gamut signal, a teletext interval corresponding to a vertical blanking interval is detected from the lines of the image signal.

Next, in operation 840, color gamut information is encoded in the data region of the detected teletext interval. More specifically, in this encoding process, codes of the color gamut information are allocated to control bits or data bits of a teletext packet, and the address of the teletext interval including the color gamut information is inserted in the header of the teletext interval.

Then, in operation 850, an image signal including the teletext packet into which the color gamut information is encoded is transmitted.

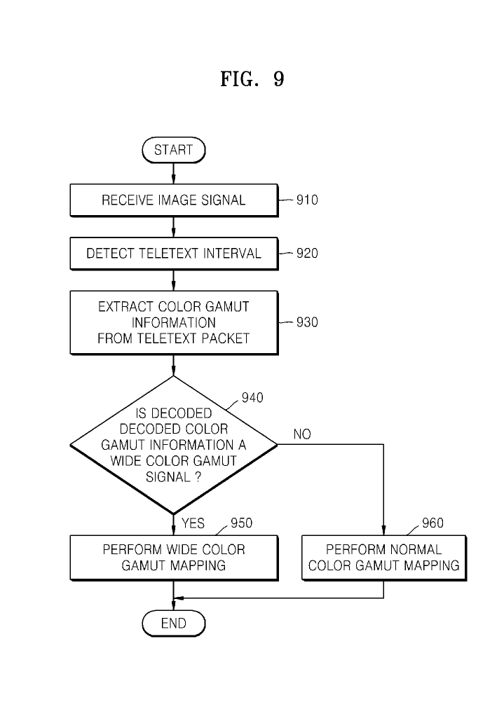

FIG. 9 is a flowchart illustrating a data receiving method according to an exemplary embodiment of the present invention. First, in operation 910, an image signal including a teletext signal obtained by encoding color gamut information in a blanking interval of the image signal is received.

Next, in operation 920, a teletext packet is detected from the image signal by extracting the blanking interval from the image signal.

Then, in operation 930, color gamut type information and primary x and y coordinate values of R, G, and B channels are decoded from the teletext packet by reading, from a header of the teletext packet, the address of the teletext packet in which the color gamut information is encoded.

Thereafter, in operation 940, it is determined whether the decoded color gamut information is a wide color gamut signal. Here, the wide color gamut signal indicates an sYCC signal, an xvYCC signal, or the like, whereas a normal color gamut signal indicates an sRGB signal or the like.

Then, in operation 950, when the decoded color gamut information is a wide color gamut signal, wide color gamut mapping is performed using the primary x and y coordinate values of the R, G, and B channels.

On the other hand, when the decoded color gamut information is not a wide color gamut signal, that is, is a normal color gamut signal, normal color gamut mapping is performed, in operation 960.

As described above, a receiving device according to the exemplary embodiments of present invention checks extension or non-extension of a color gamut from a teletext signal included in a blanking interval of an image signal received from a transmitting device, thereby performing suitable signal processing. Therefore, the receiving device may display a wide color gamut signal received from the transmitting device, without distortion.

The invention may also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A data transmitting method comprising:
determining whether a first image signal is a wide color gamut signal;
detecting a teletext interval from lines of the first image signal if it is determined that the first image signal is the wide color gamut signal;
encoding color gamut information based on the wide color gamut signal, and allocating the encoded color gamut information to a data region of the teletext interval; and
transmitting an second image signal including a teletext packet in which the encoded color gamut information is allocated.

2. The data transmitting method of claim 1, wherein the encoding the color gamut information comprises allocating the color gamut information to control bits of the teletext interval.

3. The data transmitting method of claim 1, wherein the encoding the color gamut information comprises allocating the color gamut information to data bits of the teletext interval.

4. The data transmitting method of claim 1, wherein the color gamut information comprises a color gamut type and a primary coordinate value of a color channel.

5. The data transmitting method of claim 4, wherein the color gamut type is encoded using error correction coding.

6. The data transmitting method of claim 4, wherein the primary coordinate value of the color channel is parity-coded.

7. The data transmitting method of claim 1, wherein an address of the teletext packet, in which the encoded color gamut information is allocated, is inserted in a header of the teletext packet.

8. A data transmitting method comprising:
determining whether a first image signal is a wide color gamut signal;
detecting a blanking interval from lines of the first image signal if it is determined that the first image signal is the wide color gamut signal;
encoding color gamut information based on the wide color gamut signal and allocating the encoded color gamut information to a data region of the blanking interval; and
transmitting an image signal including a packet in which the encoded color gamut information is allocated.

9. The data transmitting method of claim 8, wherein the encoding of the color gamut information comprises allocating the color gamut information to data bits of a teletext signal in the blanking interval.

10. A data receiving method comprising:
receiving an image signal including a teletext signal in a blanking interval to which coded color gamut information is added;
detecting the blanking interval from the received image signal to extract the teletext signal from the image signal;
extracting data from the teletext signal;
decoding the coded color gamut information from the extracted data; and
controlling a color gamut of a display device according to the decoded color gamut information.

11. The data receiving method of claim 10, wherein the decoding the color gamut information comprises decoding a color gamut type and a primary coordinate value of a color channel by referring to an address inserted in a header of a teletext packet.

12. The data receiving method of claim 11, wherein the controlling the color gamut of the display device comprises performing wide color gamut mapping by referring to the decoded color gamut type and the decoded primary coordinate value of the color channel.

13. A data transmitting/receiving method comprising:
encoding color gamut information if it is determined that an image signal is a wide color gamut signal, allocating the encoded color gamut information to a teletext data region, and transmitting an image signal including a teletext packet in which the encoded color gamut information is allocated; and
detecting a blanking interval from the transmitted image signal to extract teletext data from the transmitted image signal, decoding color gamut information from the extracted teletext data, and controlling a color gamut of a display device according to a coordinate value of a color channel of a color gamut indicated by the color gamut information.

14. A data transmitting device comprising:
an image signal input unit which receives a first image signal.
a control unit which checks the first image signal received by the image signal input unit to determine whether the received input image signal is a wide color gamut signal; and
a signal processing unit which encodes and allocates color gamut information to a teletext data region if the control unit determines that the image signal is a wide color gamut signal, and transmits a second image signal including a teletext interval in which the color gamut information is encoded.

15. The data transmitting device of claim 14, wherein the signal processing unit encodes the color gamut information with a color gamut type and a primary coordinate value of a color channel of the color gamut and includes the encoded color gamut information in a teletext packet in the teletext data region.

16. A data receiving device which decodes wide color gamut information from a teletext signal received from a data transmitting device to which the color gamut information is added, the data receiving device comprising:
a decoder unit which detects a teletext interval included in a received image signal and decodes color gamut information from a data region of the teletext interval;
a control unit which detects color gamut type information from the color gamut information from the data region of the teletext interval detected by the decoder unit; and
a signal processing unit which performs wide color gamut mapping using a primary coordinate value of a color channel included in the color gamut information decoded by the decoder unit, according to the color gamut type information detected by the control unit.

17. The data transmitting device of claim 16, wherein the decoder unit decodes the color gamut type information and the primary coordinate value of the color channel by referring to an address of the color gamut information that is inserted in a header of a teletext packet.
